(19) United States
(12) Patent Application Publication
(10) Pub. No.: US 2013/0312617 A1
(43) Pub. Date: Nov. 28, 2013

(54) MOBILE SELF-CONTAINED BREWER AND CUP

(71) Applicant: Alexander Toporovsky, La Mesa, CA (US)

(72) Inventor: Alexander Toporovsky, La Mesa, CA (US)

(21) Appl. No.: 13/898,804

(22) Filed: May 21, 2013

Related U.S. Application Data
(60) Provisional application No. 61/688,974, filed on May 24, 2012.

(51) Int. Cl. A47J 31/00

(52) U.S. Cl. CPC A47J 31/005
USPC 99/280; 99/316

(57) ABSTRACT

A mobile and portable device used to brew a beverage using a 12 volt power source. The device includes a top cup with a removable lid and a bottom reservoir with a heating element to boil water. A transfer tube transfers the heated water through a check valve and into a packet containing a substance resting on a platform, the water becoming an infused beverage and moving through an orifice in the bottom of the cup and into a transfer tube in the cup, filling the cup with the infused beverage.

### RELATED APPLICATIONS

This application claims the benefit of priority of U.S. Provisional Application Ser. No. 61/688,974, filed May 24, 2012, which is incorporated herein by reference.

### FIELD OF THE INVENTION

The present invention relates to an apparatus for brewing a liquid in a self-contained, mobile, and portable brewer and cup.

### BACKGROUND

Our current society is very mobile and spends much of their day on the road. There are fast food and coffee houses everywhere for a person to stop and get something to eat or drink. When purchasing coffee from a fast food store or a coffee house, the liquid can be boiling hot and is normally placed into a foam cup with a lid. Sometimes a heat protection wrapper is provided and sometimes it is not. Some of the lids have an opening for drinking, or an X for inserting a straw, and some are merely a cap. If the hot beverage in the cup spills onto the person, it may burn them. The mere fact that you have to stop or use the drive-thru to get cup of hot coffee, or tea can take a significant amount of time and money.

Many people brew a cup of coffee at home and pour it into a foam cup, a thermos, a ceramic cup, a metal cup or some other portable container with a lid in order to take it with them to work or just to have around the house. It takes time to make the coffee before the person can drink it. Many people may use instant coffee where only hot water has to be added in order to save time.

There are many devices that can be used to make the coffee. Some people use a conventional coffee maker where ground coffee is placed on a filter pouch; water is poured into a heating area where the water is heated. The heated water then drips over the ground coffee and into a pitcher type container which is stored below the area containing the ground coffee. The brewed coffee is then poured from the pitcher into a cup for drinking. The coffee is not usually consumed directly from the pitcher. Most home coffee makers are plugged into the household's 120 volt electrical outlet in order to heat the water.

Other people use a percolator type coffee maker where water is placed into a container and ground coffee is placed in a strainer on a percolating tube. The water can be heated either electrically or over a gas stove. The water percolates up through the percolating tube and drips down over the ground coffee and back down into the heated water, becoming the infused beverage (coffee). In addition, percolators are generally designed to recycle the infused liquid through the same ground coffee over and over again. Thus, the amount of time the liquid is boiled and the number of times the infused liquid is recycled determines the strength of the coffee. In order to consume the brewed coffee, the heated coffee must be poured from the percolator into separate cup. This same methodology can be used for tea, apple cider, hot coco or any other substance used for an infused beverage.

Therefore a need exists for a mobile and portable system that will make an infused beverage.

### SUMMARY

It is an advantage of the present invention to provide an apparatus that will make an infused beverage such as coffee, tea, apple cider, or any other heated beverage. In the preferred embodiment, the apparatus is mobile and portable using 12V DC electricity as the heater source of power.

It is another advantage of the present invention to provide an apparatus that forces water through a coffee or tea bag in a single pass, forming an infused product, before transferring the infused product to a top reservoir cup assembly for consumption.

It is yet another advantage of the present invention to provide an apparatus that is brewed and consumed from a single container or self-contained brewer/cup assembly.

It is no less another advantage of the present invention to provide an apparatus that can use either the 12V DC electricity or 120V AC household electricity with an additional adaptor to convert the 120V AC to 12 VDC.

An additional advantage of the present invention provides an apparatus that separates heated water in a heating reservoir from the infused beverage using check valves.

In another embodiment the present invention provides an apparatus with an upper reservoir, a first hollow interior, a first outer surface, a first inner surface, a first open upper end, a first lower planar closed end with a first orifice, and a lower reservoir, a second hollow interior, a second outer surface, a second inner surface, a second open upper end, and a second lower planar closed end.

In addition, another embodiment of the invention provides a first transfer tube, a first inner diameter, a first outer diameter, a first flared inlet end, a first outlet end, and a first bottom surface with a first orifice. And this same embodiment of the invention provides a second transfer tube, a second inner diameter, a second outer diameter, a second flared inlet end and a second outlet end, the outlet end attached to a flat platform, the flat platform having a second outer diameter with a raised edge, wherein the first transfer tube has a first one way check valve and the second transfer tube has a second one way check valve.

These and other objects, features and advantages of the present invention will become more apparent in light of the following detailed description of preferred embodiments thereof, as illustrated in the accompanying drawings.

### BRIEF DESCRIPTION OF THE DRAWINGS

The present invention will be more clearly understood from the following detailed description of the preferred embodiments of the invention and from the attached drawings, in which:

FIG. 1 is a perspective view of internal and external components of the self-contained cup;

FIG. 2 is a perspective view of the external components of the self-contained cup;

FIG. 3 is a perspective view of the top reservoir transfer tube;

FIG. 4 is a perspective view of the bottom reservoir platform and transfer tube;

FIG. 5 is an expanded view of the heating elements;

FIG. 6 is a plan view of the 12 Volt DC connector and cable;

FIG. 7 is an enlarged view of the LED light and alarm module;

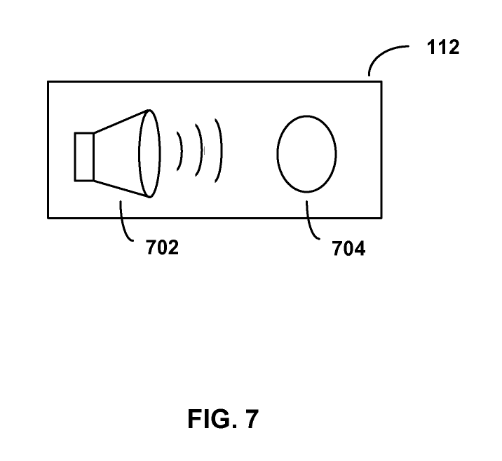

FIG. 8 is an perspective view of the bottom reservoir, bottom reservoir platform and transfer tube;

FIG. 9 is a side perspective picture of the self-contained cup with the power coil;

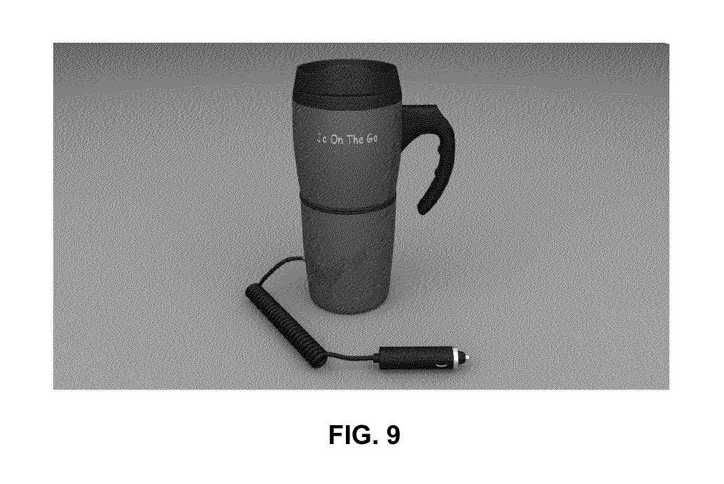

FIG. 10 is a top perspective picture of the top reservoir with a beverage;

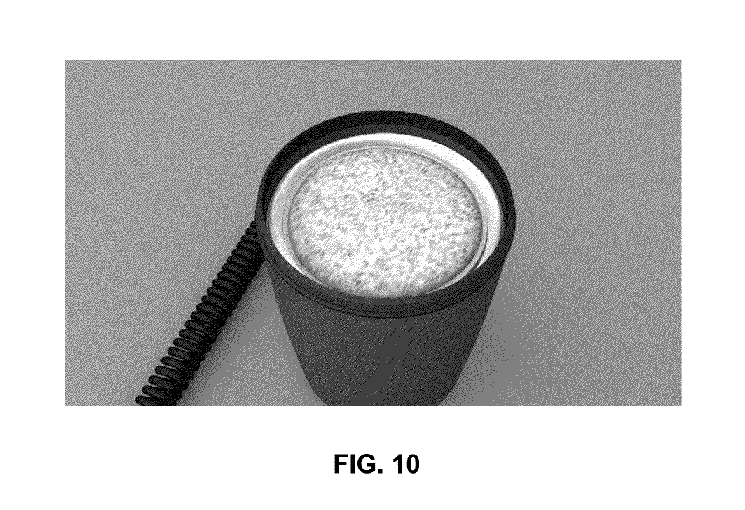

FIG. 11 is a top perspective picture of the bottom reservoir and heating element.

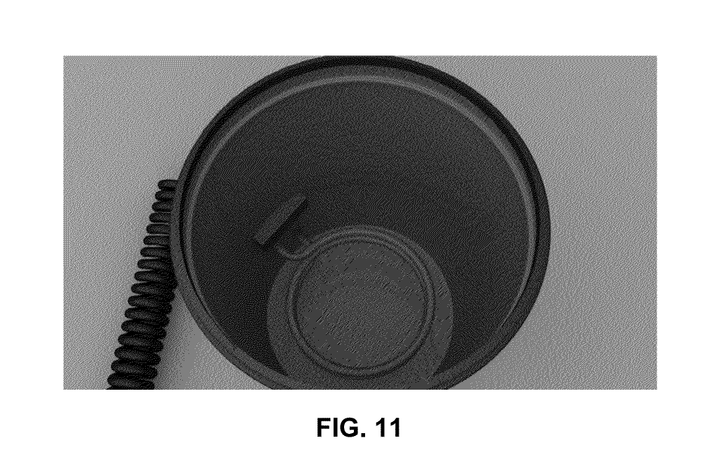

In the attached figures, multiple figures may have the same reference numeral indicating similar components and/or features.

### DETAILED DESCRIPTION

Before the invention is described in detail, it is to be understood that unless otherwise indicated, this invention is not limited to any particular materials, size, or the like, as such may vary. It also is to be understood that the terminology used herein is for the purposes of describing particular embodiments only, and is not intended to be limiting.

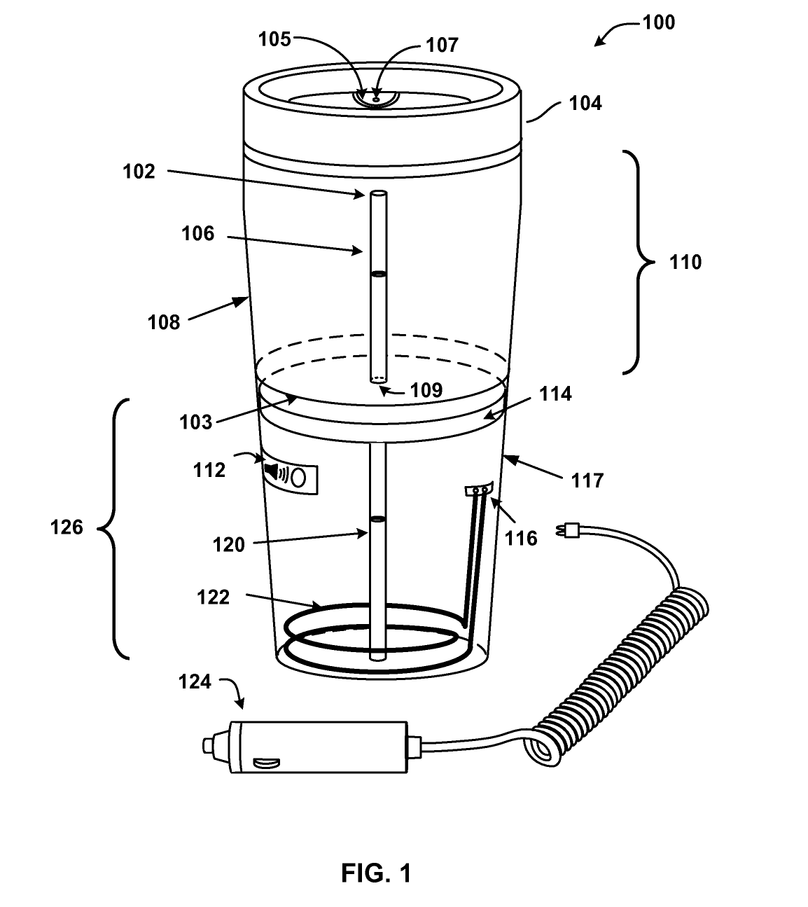

Illustrated in FIG. 1, a self-contained cup assembly 100 is made up of three parts. The first part includes a detachable lid 104, the second part includes a top reservoir cup 110, and the third part is a bottom reservoir brewing chamber 126. As further illustrated in FIG. 1, the top reservoir cup 110 includes a sidewall enclosure 108 and a bottom surface 103. Materials used to form the interior and exterior of the cup assembly may include but is not limited to stainless steel, plastic, ceramic or other durable, non-porous, non-corrosive, non-toxic material. In addition, methods of forming the self-contained cup assembly 100 include but are not limited to injection molding, robotic molding, CNC machining, and advanced stereolithography 3D printing.

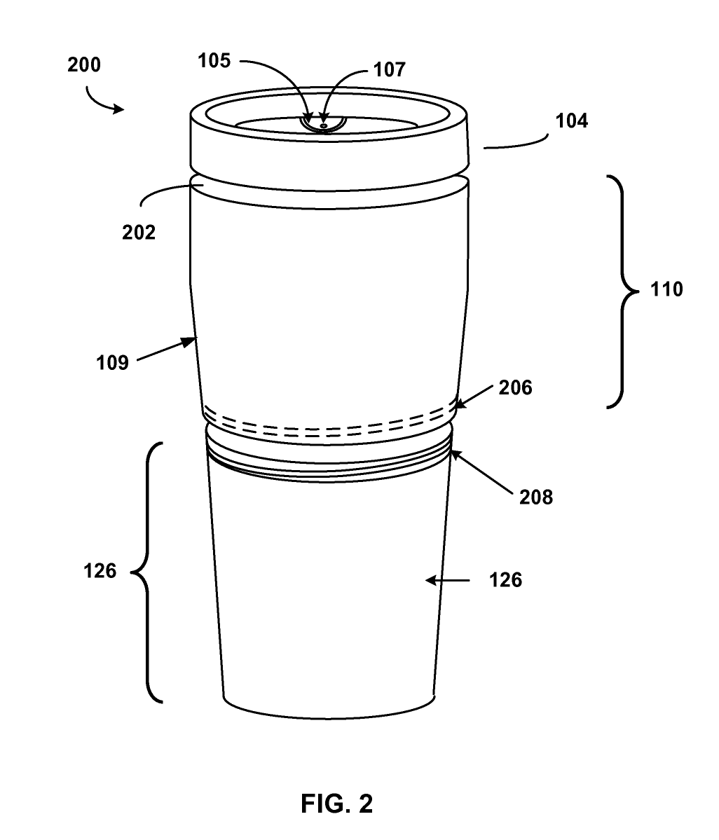

FIG. 2 illustrates an exterior view 200 of the cup assembly 100 shown in FIG. 1. In FIG. 2, the sidewall enclosure 108 of the top reservoir cup 110 is generally cylindrical in shape with an upper open end 202 and the bottom surface 103 connected to the sidewall enclosure 108 forming the top reservoir cup 110. The bottom end of the top reservoir cup 110 includes an internal thread 206 such that it mated to a corresponding external thread 208 of the bottom reservoir brewing chamber 126, forming a single cup and brewer assembly. This assembly design provides easy separation of the cup and brewer assembly for access to the inner components and cleaning. Other means to mate the top reservoir cup 110 to the bottom reservoir brewing chamber 126 includes but is not limited to snaps and form fitted fasteners.

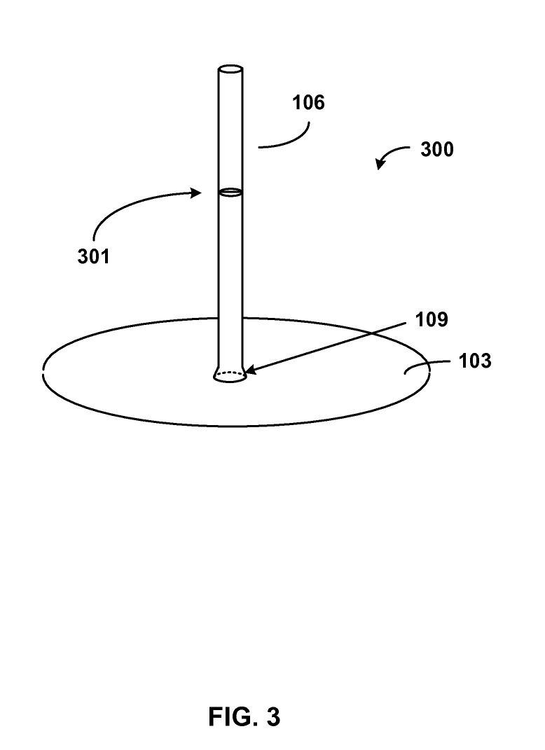

Referring back to FIG. 1, a top reservoir transfer tube 106 is connected to the bottom surface 103, forming a top reservoir transfer assembly. In one example, the reservoir transfer tube 106 and the bottom surface 103 may be formed as an inseparable piece. In another example, the transfer tube 106 may be connected to bottom surface 103 using a pressure fit, a mechanical threaded style fastener, or other similar fastening mechanisms that allows the reservoir transfer tube 106 to detach from the bottom surface 103, making these separable parts easy to clean and less expensive to replace than the former example. This transfer assembly is further illustrated in detail in FIG. 3. The reservoir transfer assembly 300 has an orifice 109 formed at the center of the bottom surface 103 which is coupled to the top reservoir transfer tube 106, forming the transfer assembly structure 300. In practice, the reservoir transfer assembly 300 may be made of a non-corrosive metal, non-toxic, durable plastic or rubberized material that is suitable for high temperature applications. In another implementation, multiple transfer tubes may replace the single transfer tube 106 design as to increase the volume of liquid from the reservoir brewing chamber 126 to the reservoir cup 110.

In FIG. 1 and FIG. 3, the top reservoir transfer assembly 300 is formed as a single unit so that the bottom surface 103 is connected to the inner sidewall enclosure 108 of the top reservoir cup 110, forming the reservoir cup 110. The bottom of the top reservoir transfer tube 106 aligns with the orifice 109 at the center of the bottom surface 103 of the reservoir cup 110.

As illustrated in FIG. 3, the top reservoir transfer tube 106 includes a one way check valve 301 which is located inside the transfer tube 106. In operation, the check valve 301 is used to prevent any heated liquid from flowing back down into the bottom reservoir brewing chamber 126, forcing the liquid to flow into the cup 110.

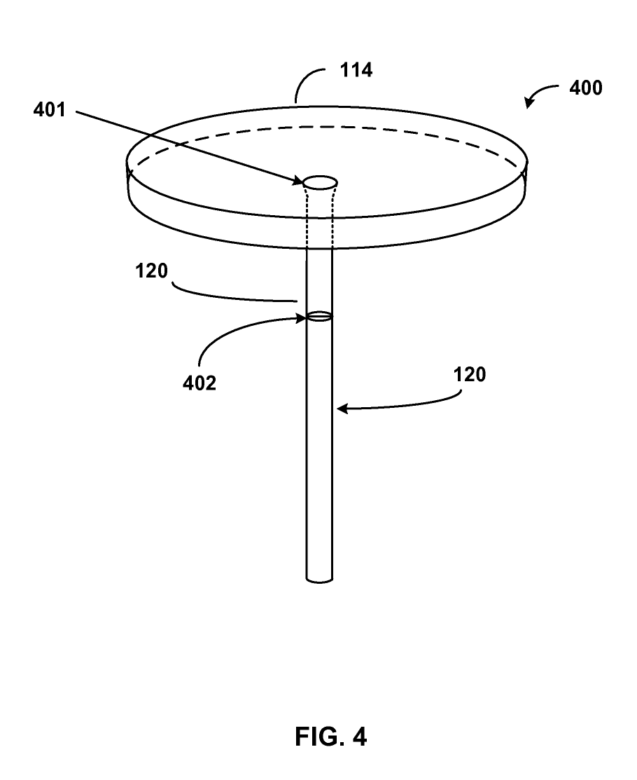

FIG. 4 illustrates a bottom reservoir transfer assembly 400 which includes a bottom reservoir platform 114 that is connected to a bottom reservoir transfer tube 120. The reservoir platform 114 is generally cylindrical in shape with the top portion open and the bottom portion closed. An orifice 401 is formed in the center of the closed bottom portion of the bottom reservoir platform 114. The bottom reservoir transfer tube 120 is coupled to the bottom reservoir platform 114 through the orifice 401, forming the bottom transfer assembly structure 400. Materials such as a non-corrosive metal, non-toxic, heat-resistant, durable plastic or rubberized material may be used to fabricate the transfer assembly structure 400.

The bottom reservoir transfer tube 120 includes a one way check valve 402 which is located inside the transfer tube 120.

In operation, the check valve 402 prevents any heated liquid from flowing back down into the bottom reservoir brewing chamber 126, forcing additional heated liquid to flow into the cup 110.

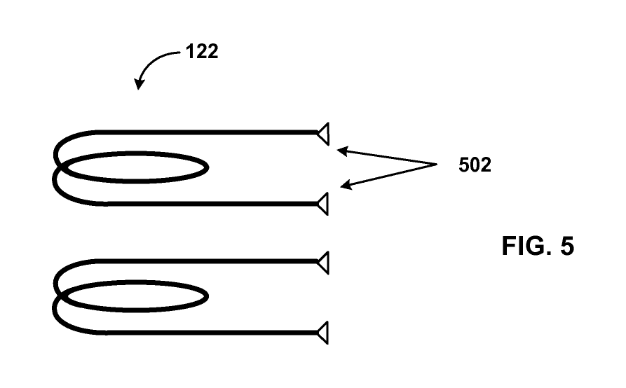

Referring to FIG. 1 and FIG. 5, a heating element 122 is attached to a connector assembly 116 of the reservoir brewing chamber 126. In one implementation, the heating element 122 may be formed using a coil having an electrical input/output end 502 as shown in FIG. 5. The heating element 122 may be made of a resistive alloy such that the coil will heat up sufficiently to boil water when a voltage is applied. However, other types and shapes of heating elements may be used so long as the material is non-corrosive, non-toxic, and water resistant. Both the input end and the output end are located in and electrically connected to the connector 116. The connector 116 is attached to the inner side of the bottom reservoir brewing chamber 126 and is insulated from any liquid within the bottom reservoir brewing chamber 126. The connector penetrates through the side wall of the bottom reservoir brewing chamber 126 and is sealed so no liquid will leak out of the cup. The connector 116 may act as a switch for shutting power off to the heating element 122.

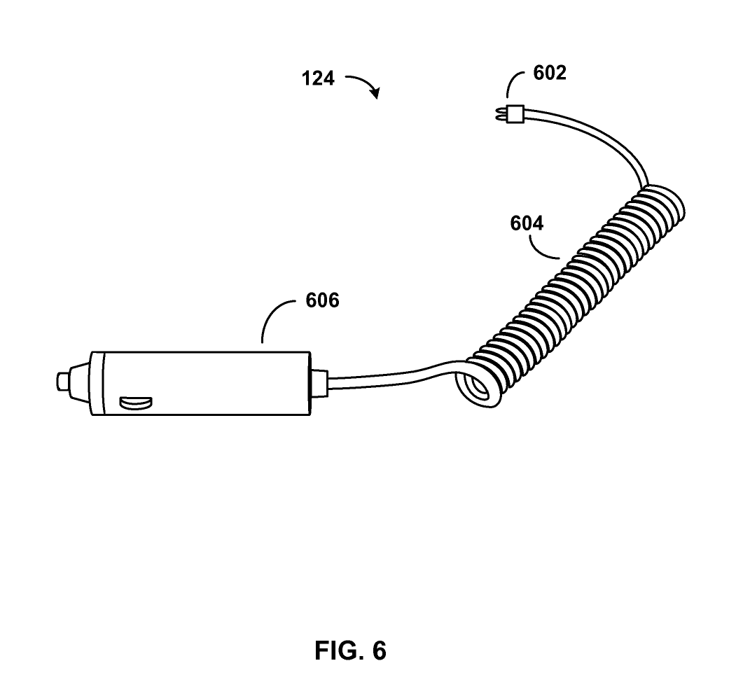

Referring to FIG. 1 and FIG. 6, a 12V DC connector assembly 124 includes a two prong connector 602 specifically designed to mate with the connector 116. The two prong connector 602 is electrically connected to a cable coil 604 which in turn is connected to a 12 volt DC connector plug 606. The 12 volt DC connector plug 606 is designed to plug into a vehicle's cigarette lighter or a 12 volt power outlet, for example. In

FIG. 1, power from the 12 volt power source is delivered to the cup assembly 100 via the connector assembly 124 where an electrical connection at the two prong connector 602 is made with the heating element 122. Other power sources include solar and battery sources, for example, which may be used to supply the 12V DC power to the cup assembly 100.

Referring back to FIG. 1, the detachable lid 104 is fastened to the top of the top reservoir cup 110, providing a watertight seal to the liquid contents of the cup assembly 100. The detachable lid 104 is generally cylindrical in shape and has a snap flap 105 with a pin hole 107. The pin hole 107 is used to vent any pressure buildup when the infused beverage fills the top reservoir cup 110. When the snap flap 105 is open, a hole is exposed allowing a person to drink the beverage. In another embodiment, the snap flap may be a slide flap or any other means of closing the hole. Various pin hole implementations include but is not limited to a rectangular slot and multiple pin holes. In yet another embodiment, the small vent hole 107 may be placed in the center of the flat planar portion of the detachable lid 104 or anywhere else in the flat planar portion.

Referring to FIG. 1 and FIG. 2, an LED and alarm module 112 is located on an outer surface of the upper portion of the bottom reservoir brewing chamber 126. The LED and alarm module 112 is electrically attached to the connector 116. The alarm speaker 702 will emit a sound and the LED light 704 will light up providing notice when the brewing process is complete and it is time to disconnect the power source. In another embodiment, the LED and alarm module 112 may provide an automatic electrical shutoff of the power. In another implementation, sensors may be integrated into the cup assembly 100 to monitor liquid level and temperature.

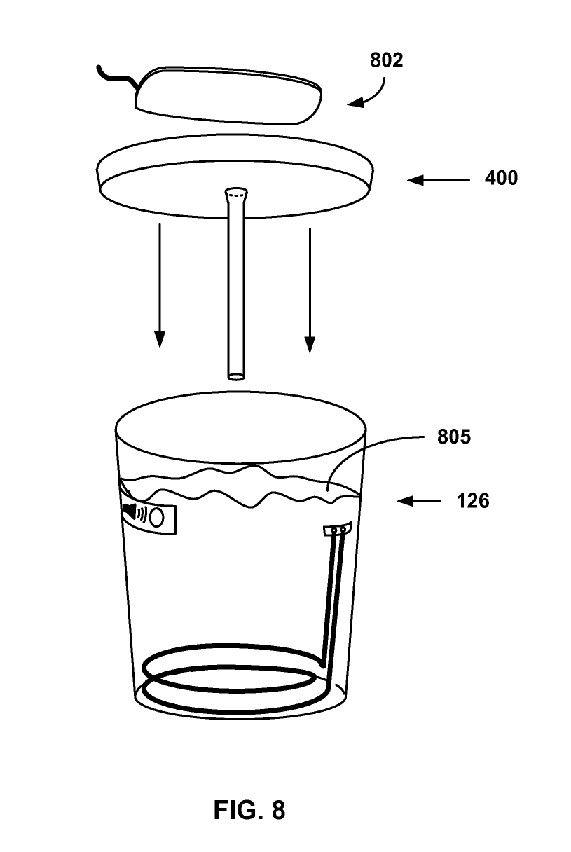

In operation, a packet 802 containing a substance which is to be infused into boiling water 805 is placed onto the top of the bottom reservoir platform 400 where the platform and packet are lowered into the bottom reservoir brewing chamber 126 as shown in FIG. 8. The substance may be coffee, tea, apple cider or any other substance a person wishes to use.

Referring to FIG. 1, FIG. 3, FIG. 4, and FIG. 8, the lower outer portion of the bottom reservoir platform 400 fits snugly against the inner side wall of the bottom reservoir brewing chamber 126. The lower outer portion of the bottom reservoir platform 400 firmly presses against the bottom of the top reservoir cup 110 forming a watertight seal when the top reservoir cup 110 is screwed onto the bottom reservoir brewing chamber 126. The bottom reservoir transfer tube 120 lightly rests on the lower inner surface of the bottom reservoir brewing chamber 126.

When water 805, or any other liquid, is added to the bottom reservoir brewing chamber 126 and power is applied to heating element 122, the water is heated to boil and pressure builds up inside the brewing chamber. The boiling water is forced up the inside of the bottom reservoir transfer tube 120. At any location within the bottom reservoir transfer tube 120, located internally in the tube, a bottom reservoir one way check valve 402 prevents heated water from flowing back down the tube. The boiling water fills the bottom reservoir platform 114 and immerses the packet 802 in the boiling water infusing the boiling water with the substance, such as coffee. As the water fully fills the bottom reservoir platform 602, the infused solution is forced up through the orifice in the bottom of the top reservoir cup 110 and into the top reservoir transfer tube 106. The infused liquid is then forced up through the top reservoir one way check valve 301 and up to the top of the top reservoir transfer tube 106 overflowing into the top reservoir cup 110 where the infused liquid will fill the top reservoir cup 110. The top reservoir one way check valve 301 prevents the infused liquid from returning downward and mixing with the heated water in the bottom reservoir brewing chamber 126. Notably, the infused liquid is delivered to the top reservoir cup 110 in a single pass, unlike percolator brewing devices that recycle the infused liquid over and over again, providing a quick, convenient, and efficient means for brewing any sort of consumable beverage.

When brewing is complete, the LED and alarm module 112 will sound and the LED light will light. The connector 116 may shut-off the power to the heating element 122 when a signal is sent from the LED and alarm module 112. The 12V DC connector assembly 124 may be removed, and the hot brewed beverage is ready for consumption and is mobile.

In a practical mobile user scenario, the self-contained mobile brewer cup assembly 100 as shown in FIG. 1 is designed to fit into a standard cup holder accessory found in most vehicles or other flat surface housing structure that prevents the cup assembly 100 from tipping over, making it convenient for the user to brew, heat, and drink any desired beverage in the single self-contained cup. In one embodiment, the bottom reservoir brewing chamber 126 may have a flared bottom for better stability.

As used in the specification and the appended claims, the singular forms “a”, “an”, and “the” included plural referents unless the context clearly dictates otherwise. Thus, for example, reference to a “heating element 302” includes a single “heating element 302” as well as a combination of two or more, and the like.

All patents, patent applications, and other references cited herein are incorporated by reference in their entireties.

It is noted that the foregoing disclosure has been provided merely for the purpose of explanation and is in no way to be construed as limiting of the present invention. Although the present invention has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present invention in its aspects.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

What is claimed is what is described and illustrated, including:

1. A self-contained mobile brewer and cup device comprising:
a top reservoir cup comprising an sidewall enclosure and a bottom surface, the bottom surface connected to one end of the sidewall enclosure;
a top reservoir transfer means comprising a top reservoir transfer tube having a distal end, wherein the distal end of the top reservoir transfer tube is connected to the bottom surface of the top reservoir cup;
a bottom reservoir brewing chamber coupled to the top reservoir cup;
a bottom reservoir transfer assembly comprising a bottom reservoir platform and a bottom reservoir transfer tube, the bottom reservoir transfer tube having a proximal end, wherein the proximal end of the bottom reservoir transfer tube is connected the bottom reservoir platform, wherein the bottom reservoir transfer assembly is disposed inside the bottom reservoir brewing chamber; and
a heating element electrically coupled to an electrical connector assembly formed in the interior of the bottom reservoir.

2. The self-contained mobile brewer and cup device as in claim 1, further comprising a detachable lid connected to the top reservoir cup.

3. The self-contained mobile brewer and cup device as in claim 2, wherein a pin hole is formed in the detachable lid, the pin hole provides a pressure relief to release pressure buildup when an infused beverage fills the top reservoir cup.

4. The self-contained mobile brewer and cup device as in claim 3, further comprising a one way check valve rigidly attached to the inner diameter of the top reservoir transfer tube.

5. The self-contained mobile brewer and cup device as in claim 4, further comprising a one way check valve rigidly attached to the inner diameter of the bottom reservoir transfer tube.

6. The self-contained mobile brewer and cup device as in claim 1, further comprising a 12 volt direct current connector electrically coupled to the heating element.

7. The self-contained mobile brewer and cup device as in claim 1, wherein one end of the top reservoir cup comprising an internal thread mated to a corresponding external thread formed onto the bottom reservoir brewing chamber, forming a single brewer and cup assembly.

8. The self-contained mobile brewer and cup device as in claim 7, wherein the single brewer and cup assembly fits into a standard cup holder accessory.

9. The self-contained mobile brewer and cup device as in claim 8, wherein the single brewer and cup assembly is used for preparing coffee, tea, apple cider, or hot coco.

10. A portable brewing device comprising:
an upper reservoir cylindrical in shape having a hollow interior, an inner surface, an open upper end, a lower planar closed end with a circular orifice disposed in the center of the lower planar closed end;
a lower reservoir cylindrical in shape having a hollow interior, an inner surface, an open upper end, a lower planar closed end;
a top reservoir transfer assembly comprising:
a bottom surface, the bottom surface having an orifice that is diametrically centered, disposed to the open upper end of the upper reservoir;
a transfer tube having an inner diameter, an upper end, and a flared lower end, the flared lower end disposed and fixedly attached to the orifice of the bottom surface forming a flow channel through the transfer tube allowing a liquid to enter through the orifice and into the transfer tube, wherein the top reservoir transfer assembly is disposed to the inner surface of the lower planar closed end of the upper reservoir forming a seal, wherein the transfer tube extends longitudinally from the lower planar closed end of the upper reservoir to the open upper end of the upper reservoir, the open upper end of the transfer tube terminating below the open upper end of the upper reservoir;
a one way check valve rigidly attached to the inner diameter of the transfer tube;
a bottom reservoir transfer assembly comprising:
a flat platform cylindrical in shape having an outer diameter, the outer diameter having raised edges for containing a packet, the flat platform having an orifice that is diametrically centered, the flat platform disposed to the inner surface of the open upper end of the lower reservoir forming a seal;
a transfer tube having a lower end and a flared upper end, the flared upper end disposed and fixedly attached to the orifice of the flat platform forming a flow channel through the transfer tube allowing a liquid to enter through the lower end and onto the flat platform, submersing the packet in the liquid;
a one way check valve rigidly attached to the inner diameter of the transfer tube; and
a heating element comprising an electrical input end, an electrical output end, a coiled section disposed to the lower planar closed end of the lower reservoir, the heating element electrically connected to a connector, wherein the connector is rigidly attached to the lower reservoir, the connector penetrating through the lower reservoir, the connector having a hole for the electrical input end and a hole for the electrical output end.

11. The portable brewing device as in claim 10, further comprising a 12 volt direct current connector having a two prong connector in electrical connection to a coiled cable in electrical connection to a 12V DC connector plug, wherein the two prong connector plugs into holes of the connector in the lower reservoir, making electrical connection to heating element and to the coiled cable and the 12V DC connector plug, wherein the 12V DC connector plug can be plugged into a cigarette lighter or a 12V DC power supply.

12. The portable brewing device as in claim 10, further comprising a handle attached to the first outer surface of the upper reservoir.

13. The portable brewing device as in claim 10, further comprising a lid cylindrically shaped, having a flat surface, an outer diameter dimensioned to snap over the first outer surface of the upper reservoir, a vent hole to allow steam to exit from the upper reservoir, the vent hole near the out diameter of the lid, and a snappable cover sealing the vent whole, the snap cover having a small hole for steam to exit.

14. A portable brewing device comprising:
an upper reservoir cylindrical in shape having a first hollow interior, a first outer surface, a first inner surface, a first open upper end, a first lower planar closed end forming a first bottom surface with a circular first orifice disposed in the center of the first bottom surface;
a lower reservoir cylindrical in shape having a second hollow interior, a second outer surface, a second inner surface, a second open upper end, a second lower planar closed end;
a first transfer tube having a first inner diameter, a first outer diameter disposed diametrically centered within the upper reservoir, the first transfer tube having a first flared inlet end and a first outlet end, the first flared inlet end fixedly attached to the bottom surface forming a flow channel through the first orifice in the first bottom surface and into the first transfer tube allowing a liquid to enter through the first orifice in the first bottom surface through the first transfer tube flowing into the upper reservoir, wherein the first transfer tube extends longitudinally from the lower planar closed end of the upper reservoir to the open upper end of the upper reservoir, the open upper end of the first transfer tube terminating below the first open upper end of the upper reservoir;
a second transfer tube having a second inner diameter, a second outer diameter, wherein the transfer tube is disposed diametrically centered within the lower reservoir, wherein the second transfer tube having a second flared inlet end and a second outlet end, wherein the second transfer tube extends longitudinally from the second lower planar closed end of the lower reservoir to the second open upper end of the lower reservoir, the second outlet end fixedly attached to a second circular orifice that is diametrically centered in a flat platform, the flat platform having an second outer diameter, at the second outer diameter of the flat platform having a raised edge for containing a packet, wherein the flat platform is disposed to the second inner surface at the second open upper end the lower reservoir forming a seal;
a first one way check valve rigidly attached to the first inner diameter of the first transfer tube between the first flared inlet end and the first outlet end,
a second one way check valve rigidly attached to the second inner diameter of the second transfer tube between the second flared inlet end and the second outlet end; and
a heating element comprising an electrical input end, an electrical output end, a coiled section disposed to the second inner surface of the second lower planar closed end, the heating element electrically connected to a connector to connect to a power source, wherein the connector is rigidly attached to the second inner surface of the lower reservoir, the connector penetrating through the second inner surface through to the second outer surface, the connector having a hole for the electrical input and output of a two prong connector.

15. The portable brewing device as in claim 14, further comprising the upper reservoir having a threaded outer surface disposed at the lower planar closed end, the treads extending longitudinally towards the open end, the lower reservoir having a threaded outer surface disposed at the open upper end, the threads extending longitudinally towards the lower planar closed end for a distance sufficient for the threaded mating of the upper reservoir to the lower reservoir, forming a watertight seal.

16. The portable brewing device as in claim 14, further comprising a 12 volt direct current connector having a two prong connector in electrical connection to a coiled cable in electrical connection to a 12 volt direct current connector plug, wherein the two prong connector plugs into the first and second hole of the connector in the lower reservoir, making electrical connection to heating element and to the coiled cable and the 12 volt direct current connector plug, wherein the 12 volt direct current connector plug can be plugged into a cigarette lighter or a 12 volt direct current power supply.

17. The portable brewing device as in claim 14, further comprising a handle attached to the first outer surface of the upper reservoir.

18. The portable brewing device as in claim 14, further comprising a lid cylindrically shaped, having a flat surface, an outer diameter dimensioned to snap over the first outer surface of the upper reservoir, a vent hole to allow steam to exit from the upper reservoir, the vent hole near the out diameter of the lid, and a snappable cover sealing the vent whole, the snappable cover having a small hole for steam to exit.
